(19) United States
(12) Patent Application Publication
(10) Pub. No.: US 2003/0122533 A1
(43) Pub. Date: Jul. 3, 2003

(54) Multiple application photodiode bias supply

(76) Inventor: Daniel C. Prescott, Tustin, CA (US)

Correspondence Address: VOLENTINE FRANCOS, PLLC, SUITE 150, 12200 SUNRISE VALLEY DRIVE, RESTON, VA, 20191, US

(21) Appl. No.: 10/039,768

(22) Filed: Dec. 31, 2001

(51) Int. Cl. G05F 3/16

(52) U.S. Cl. 323/313

(57) ABSTRACT

According to an exemplary embodiment of the present invention, an apparatus for supplying bias voltages over a relatively wide voltage range includes a bias supply having a feedback supply node and a voltage output node. The apparatus further includes a bias control voltage input, which is connected to a resistance, wherein a voltage at the feedback supply node remains substantially constant so that an output voltage of the voltage output node is adjusted in response to a change a current through the resistance.

### FIELD OF THE INVENTION

The present invention relates generally to electronics and optoelectronics, and particularly to a photodiode bias supply, which is adapted to operate over a wide range of voltages at desired resolution.

### BACKGROUND OF THE INVENTION

Optical communications systems have gained widespread acceptance in transmission of data and voice over short and long distances. In an optical communications system optical signals must be converted to electrical signals at an optical-to-electrical (OE) interface. The electrical interface in conventional optical networks typically includes a reverse-biased photodiode and supporting electronics thereof. Depending upon the requirements of sensitivity and speed, two known photodiode structures are widely used in optical communication systems. These include a p-material-intrinsic-layer-n-material (PIN) photodiode and an avalanche photodiode (APD).

While PIN and APD photodiodes ultimately accomplish the same result, namely conversion of a received optical signal to an electrical signal, their bias voltage requirements are disparate. To this end, the APD can require bias voltages that are substantially greater than that of the bias voltages for a PIN. For purposes of illustration, the APD can require bias voltages as great as 85V (and greater), depending upon the semiconductor material of which the APD is comprised, in order to produce avalanche conditions. In contrast, the reverse bias requirements of a PIN detector are significantly lower, on the order of approximately 5V to approximately 20V. More importantly, the voltage requirements of an APD are greater than the reverse bias breakdown potential of most PIN detectors. As such, conventional receiver designs are differentiated by the type of photodiode employed within the design, which dictates the topology of the photodiode bias circuitry.

Conventionally, in order to support a variety of different optical receiver requirements, and particularly sensitivity requirements, a minimum of two separate hardware platforms are necessary to accommodate both PIN and APD-based receiver designs, as a result of the different supply voltage requirements. This conventional approach is disadvantageous at least from the perspective of manufacturing logistics.

What is needed, therefore, is a bias supply circuit which overcomes at least the disadvantages of conventional approaches described above.

### SUMMARY OF THE INVENTION

According to an exemplary embodiment of the present invention, an apparatus for supplying bias voltages over a relatively wide voltage range includes a bias supply having a feedback supply node and a voltage output node. The apparatus further includes a bias control voltage input, which is connected to a resistance, wherein a voltage at the feedback supply node remains substantially constant so that an output voltage of the voltage output node is adjusted in response to a change a current through the resistance.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a schematic diagram of a multiple application bias supply electrically connected to a TransImpedance Amplifier (TIA)-based optical receiver in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

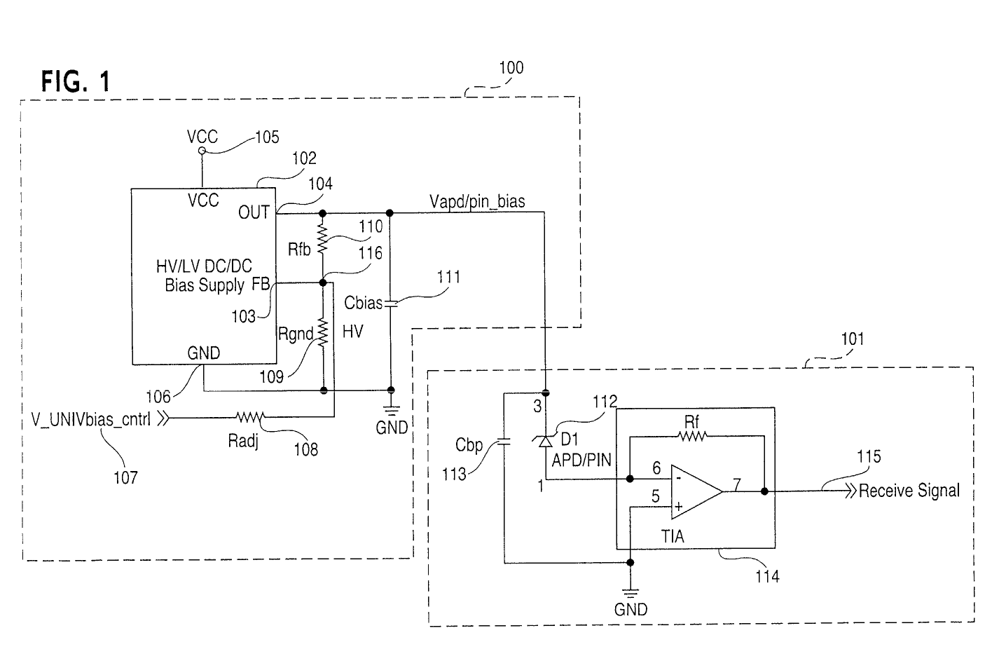

A multiple application bias supply (MABS) 100 in accordance with an exemplary embodiment of the present invention is shown in FIG. 1. The MABS 100 is electrically connected to optical receiver circuit 101, which is illustratively a TIA-based optical receiver circuit. The optical receiver circuit 101 includes a photodetector 112 which is illustratively either an avalanche photodiode (APD) or a PIN photodiode, depending upon the particular application of the optical receiver circuit 101. The photodetector 112 is typically reverse-biased. A bypass capacitor 113 is usefully included in parallel to the photodetector 112. A transimpedance amplifier 114 is used to amplify the output of the photodetector 112. The output of the transimpedance amplifier is the received signal 115.

The MABS 100 illustratively includes a high voltage/low voltage (HV/LV) DC-to-DC bias supply (hereinafter referred to as bias supply 102). The bias supply 102 includes a feedback supply node 103 and a voltage output node 104. The bias supply 102 further includes a supply voltage (V_{cc}) input 105 and a ground input 106. The MABS 100 also includes a universal bias control voltage input 107. Illustratively, the voltage level at the universal voltage control input 107 is adjustable, and a resistance R_{adj} 108 is fixed. It is noted that, alternatively, the universal bias control voltage input 107 may be at a fixed voltage level, and the resistance R_{adj} 108 may be adjustable. In either case, the current through resistance R_{adj} 108 may be varied. A feedback resistance R_{FB} 110 and a ground resistance R_{gnd} 109 are also included to effect a desired variation in the voltage output level at voltage output node 104. Finally, a bias capacitor 111 suitable for high voltage applications is connected from the voltage output node 104 to ground for noise filtering purposes. The high-voltage nature of the bias capacitor enables universal accommodation of both high and low-voltage applications.

The MABS 100 shown in FIG. 1 enables a voltage output node 104 to be input at the photodetector 112 which is commensurate with the voltage requirements of the photodetector 112. As is known, an avalanche photodiode exhibits a multiplication factor (M) that is dependent upon the applied reverse bias voltage (voltage output node 104). Moreover, the frequency response of the APD is dependent upon the multiplication factor. Accordingly, the frequency response of the APD is dependent upon the reverse-bias voltage. This voltage dependence of the APD mandates that the APD bias voltage supply be adjustable having suitable resolution dictated by the requirements of the intended application in order to enable calibration of the optical receiver 101. Moreover, as will become more clear as the present description proceeds, not only does the voltage level at voltage output node 104 need to be adjustable, but also it is useful to have the resolution of the adjustability variable depending upon the type of photodetector deployed in optical receiver 101. Of course, these requirements are in addition to the requirement of enabling a rather broad swing of the voltage at voltage output node 104 to accommodate devices having disparate voltage requirements (e.g. the illustrative APD and PIN photodetectors).

The voltage level at voltage output node 104 must have a suitable range so as to enable reverse bias of either an APD photodetector or a PIN photodector in accordance with an exemplary embodiment of the present invention. In the illustrative embodiment of FIG. 1, the DC-to-DC converter 102 is illustratively a switching, boost-converter that utilizes proportional-feedback control. The output voltage level at voltage output node 104 is controlled by maintaining the voltage level at the feedback supply node 103 at a substantially constant level. This results in a substantially constant current through R_{gnd} 109. Moreover, the current into node 116 must equal the current out of node 116 (i.e., the current through resistance R_{FB} 110 plus the current through resistance R_{adj} 108 must equal the current through resistance R_{gnd} 109). Accordingly, if the current through resistance R_{adj} 108 varies, and the current through resistance R_{gnd} 109 is a constant, the current through resistance R_{FB} 110 must also vary. For example, if the current through resistance R_{adj} 108 increases, the current through the resistance R_{gnd} 109 decreases. As can be appreciated, therefore, the greater the current through the feedback resistance (R_{FB}) 110, the higher the output voltage at voltage output node 104. Similarly, the less the current through feedback resistance R_{FB}, the lower the output voltage at voltage output node 104. Thereby, reducing the current through the resistance R_{adj} 108 will result in an increase in the current through resistance R_{FB} 110, thus increasing the voltage output node 104. As such, the reverse bias voltage of the photodetector 112 is readily increased through the adjustment of the output voltage level at voltage output node 104.

Variation of the current through resistance R_{adj} 108 (and therefore through resistance R_{FB} 110) may be accomplished by adjustment of the voltage level at the universal bias control voltage input 107. This adjustability may be achieved by having the voltage level at universal bias control voltage input 107 be adjustable. To this end, a digital-to-analog converter (DAC) generated variable voltage source may be used at the universal bias control voltage input 107 to inject a control current into the node 116 through the resistance (R_{adj}) 108. An alternative technique is to adjust the resistance (R_{adj}) 108 which adjusts the ratio of the resistances, thereby altering the current into node 116, and thereby through the feedback resistance 110.

One technique useful in achieving the desired variability of the resistance R_{adj} 108, is to use a digitally-controlled potentiometer (DPOT) for this resistance. Of course, this will result in the adjustment of the voltage level at the voltage output node 104. The current into node 116 (and thus the voltage level at voltage output node 104) may also be controlled by varying the resistance of the ground resistance (R_{gnd}) 109, while maintaining the voltage at the universal bias control voltage input 107 at a constant level. Again, one technique for achieving this end is through the use of a digitally-controlled potentiometer (DPOT) as the ground resistance 109. It is noted that the above techniques for controlling the output voltage level of the voltage output node 104 may be used exclusively, or in combination; and that further techniques could be used to achieve the desired end.

According to the illustrative embodiments described above, by any technique, the voltage level at the voltage output node 104 is adjusted when a change in he current into node 116 occurs. To this end, the voltage at the feedback supply node 103 is maintained at a substantially constant level by the DC-to-DC bias supply 102, which has an integral comparator and reference voltage. The constant voltage at feedback supply node 103 effects a constant current through resistance R_{gnd} 109; and any change in current into node 116 is reflected in a change in the respective currents through resistance R_{adj} 108 and resistance R_{FB} 110. Accordingly, the output voltage level at voltage output node 104 will be adjusted as a result of the constant voltage at feedback supply node 103, thereby setting a constant current through each resistance (R_{adj} 108, R_{gnd} 109, R_{FB} 110), for each setting of the output voltage at voltage output node 104. For example, if either or both resistances R_{adj} 108 and R_{gnd} 109 are varied, the resistor ratio of these resistors and the feedback resistance R_{FB} 110 is altered. However, by virtue of the comparator of the DC-to-DC bias supply 102, the voltage level at the feedback supply node 103 remains constant, while the current through resistance R_{FB} 110 and resistance R_{adj} 108 vary as a result of the change in resistance. As such, the voltage output node 104 necessarily changes. Alternatively, a change in the bias control voltage 107 can result in a change in the current through resistance R_{adj} 108. The output voltage level at the voltage output node 104 necessarily changes to maintain the current into node 116 at a substantially constant level. To wit, the current into node 116 is, of course, equal to the current flowing out of node 116 into the ground resistance 109, and is equal to the reference voltage at feedback supply node 103 divided by the ground resistance R_{gnd} 109. Advantageously, therefore, the output to the photodetector 112 of the optical receiver 101 may be effected using a universal hardware platform to accommodate both the APD and PIN-based optical receivers via relatively simple adjustment of the voltage level at the universal bias supply input 107 or varying resistances as described; and without the need for significant variation in the configuration, and especially configuration jumpers which are typically employed in conventional structures.

According to the above described illustrative embodiment, typical reference voltages for node feedback supply node 103 are between approximately 1.25V and approximately 1.5V. In order to minimize power loss in resistance R_{FB} 110, the maximum bias current should be on the order of approximately 1 mA. This dictates that resistance R_{gnd} 109 be between approximately 1 kΩ and approximately 10 kΩ. Moreover, resistance R_{FB} 110 and resistance R_{adj} 108 will be dictated by the maximum output voltage level at voltage output node 104 and the range of adjustment from the maximum output voltage level at voltage output node 104, as well as the desired control scheme, whether it be an adjustable voltage or potentiometer. Finally, it is noted that the resistance connected to the bias control voltage input illustratively comprises a plurality of resistors (e.g. R_{FB} 110, R_{gnd} 109 and R_{adj} 108 may be resistors used in the electronic arts), and at least one of these resistors may be variable over a desired range.

As referenced previously, another advantageous aspect of the present invention is the ability to alter the resolution of the variation of the voltage depending upon the application. For example, an avalanche photodetector typically requires the capability to vary the voltage across a particular range during calibration, and this variation in the voltage must be variable by defined increments. In PIN photodetector applications, the requirements for the reverse bias voltage are significantly less than that for the avalanche photodiode. In addition, the PIN voltage variation is on the order of approximately ±5%, and does not require the resolution that the APD requires. In particular, in order to obtain the desired voltage accuracy for APD multiplication factor adjustment, the voltage must be adjustable in increments better than 1% of full scale.

The MABS 100 enables the variation of the reverse bias voltage through variation of the voltage output node 104 over the full dynamic range of the photodetector 112. To this end, the voltage variation and resolution of calibration may be readily tailored to the particular photodetector of a particular application. In accordance with an exemplary embodiment of the present invention, the degree of resolution may be effectively controlled through the appropriate selection of the digital potentiameter (DPOT) which serves as the resistance R_{gnd} 109. Alternatively, the required degree of resolution is achieved by specifying the resolution of the voltage-control mechanism to generate the input bias voltage 107. The resolution of the selected control mechanism is usefully greater than about 1% for most applications and may be implemented with readily available Digital-to-Analog Converters (DACs) or DPOTs that feature 8-bit precision (0.39% accuracy).

As can be readily appreciated by one having ordinary skill in the art, because the application of the MABS 100 to an optical receiver 101 incorporating an APD for the photodetector 112 requires the greatest resolution, the above referenced parameters are illustrative of the resulting power of such an application. Of course, in the application where a PIN photodetector is used in the receiver 101, resolution of the voltage variation to this degree is generally not required, but is not disadvantageous nonetheless.

For purposes of illustration, and not limitation, consider an illustrative embodiment in which the voltage swing for an APD is in the range of 20V to 40V, with a resolution of 0.4V increments. It may be then necessary to increase the output voltage adjustment range to include voltages below the minimum APD bias of 20V to accommodate a PIN application requiring, for example, only 10V. Because the 0.4V incremental change voltage is still advantageous, the increase in the resolution for this change in voltage would go from two-to-one to four-to-one. This may be effected through variation at the DPOT, or at the universal bias control input 107. The illustrated doubling of required accuracy to achieve the wider adjustment range would dictate a control mechanism (DPOT or DAC) with one bit higher precision to accommodate both PIN and APD applications.

Finally, another particular advantage of the present invention enables the use of the monitored photodiode current in the calibration stage of the production process to prevent damage to a PIN-based receiver which has been inadvertently installed in an APD-based receiver circuit. Typically, the receiver photodiode current is monitored to determine a loss of power (LOP) condition. This function may be implemented using a current-mirror circuit in order to level-shift the detected current relative to ground potential. In order to prevent damage to a PIN-detector inadvertently installed, the following procedure can be applied using the MABS 100 of the exemplary embodiment of the present invention shown in FIG. 1.

First, upon power-up, the default voltage output node 104 is a low voltage, on the order of approximately 5V to approximately 7V. Next, a photodiode dark current is measured using the current monitor function to determine the offset current (Iₒₛ) Next, an optical receive signal of nominal power is applied while current monitoring is active to identify the type of photodiode current present. To wit, if active current (above offset) is detected, the installed detector type is a PIN, otherwise the installed detector type is an APD. (As is known, APD photodiodes require a larger bias voltage than PIN photodiodes to achieve a multiplication factor of M=1 (due to recombination), thus allowing the distinction between types at low voltage). If it is determined that the wrong detector has been installed, it may be removed to avoid damage to the device, in the event that a PIN detector has been installed instead of an APD. Of course, if an APD has been inadvertently installed instead of a PIN detector, this would also be revealed using the above referenced process.

It is noted that the above application of the MABS 100 has been illustrated in connection with an optical receiver circuit 101 which includes a voltage-sensitive photodetector 112. It is of interest to note, however, that the MABS 100 may be useful in other applications where a voltage sensitive device is biased by the MABS 100. Clearly, the voltage-sensitive device may or may not be an optoelectronic device, and in fact may be an electronic device.

The invention having been described in detail in connection through a discussion of exemplary embodiments, it is clear that various modifications of the invention will be apparent to one having ordinary skill in the art having had the benefit of the present disclosure. Such modifications and variations are included within the scope of the appended claims.

I claim:

1. An apparatus for supplying bias voltages over a relatively wide voltage range, comprising:
A bias supply having a feedback supply node and a voltage output node; and
a bias control voltage input which is connected to a resistance, wherein a voltage level at said feedback supply node remains substantially constant so that an output voltage of said voltage output node is adjusted in response to a change in a current through said resistance.

2. An apparatus as recited in claim 1, wherein said resistance is fixed.

3. An apparatus as recited in claim 2, wherein said bias control voltage is variable.

4. An apparatus as recited in claim 1, wherein said resistance is variable.

5. An apparatus as recited in claim 4, wherein said bias control voltage is constant.

6. An apparatus as recited in claim 1, wherein said resistance includes a plurality of resistors, and at least one of said resistors is variable; and wherein a current through one of said plurality of resistors remains substantially constant for all voltage levels of said bias control voltage input.

7. An apparatus as recited in claim 6, wherein said at least one variable resistor is a digital potentiometer.

8. An apparatus as recited in claim 3, wherein said variable bias control voltage is a digital-to-analog converter.

9. An apparatus as recited in claim 1, wherein the bias voltages are supplied to a photodetector.

10. An apparatus as recited in claim 9, wherein said photodetector is an avalanche photodiode.

11. An apparatus as recited in claim 9, wherein said photodetector a PIN photodiode.

12. An apparatus as recited in claim 1, wherein the voltage range is approximately 5V to approximately greater than 85V.

13. An apparatus as recited in claim 1, wherein said bias supply is a DC-to-DC converter.

14. An apparatus adapted to supply a bias voltage to either an avalanche photodiode or a PIN photodiode over a relatively wide voltage range, comprising:
A bias supply having a feedback supply node, and a voltage output node; and
a bias control voltage input which is connected to a resistance, wherein a voltage level at said feedback supply node remains substantially constant so that an output voltage of said voltage output node is adjusted in response to a change in a current through said resistance.

15. An apparatus as recited in claim 13, wherein said resistance is fixed.

16. An apparatus as recited in claim 14, wherein said bias control voltage is variable.

17. An apparatus as recited in claim 13, wherein said resistance is variable.

18. An apparatus as recited in claim 16, wherein said bias control voltage is constant.

19. An apparatus as recited in claim 16, wherein said variable resistor is a digital potentiometer.

20. An apparatus as recited in claim 15, wherein said variable bias control voltage is a digital-to-analog converter.

21. An apparatus as recited in claim 13, wherein the voltage range is approximately 5V to approximately greater than 85V.

22. An apparatus as recited in claim 14, wherein said resistance includes a plurality of resistors, and at least one of which is variable; and wherein a current through one of said plurality of resistors remains substantially constant for all voltage levels of said bias control voltage input.
